(19) United States
(12) Patent Application Publication
(10) Pub. No.: US 2013/0254097 A1
(43) Pub. Date: Sep. 26, 2013

(54) Methods, Systems, and Products for Charging Batteries

(71) Applicants: NIKHIL S. MARATHE, ROSELLE, IL (US); CHRISTOPHER F. BALDWIN, CRYSTAL LAKE, IL (US); BRUCE BARNES, I, PINGREE GROVE, IL (US); PATRICK JOHN KENNY, BARRINGTON, IL (US); SHADI KHOSHABA, SKOKIE, IL (US); CHARLES STAHULAK, CHICAGO, IL (US)

(72) Inventors: NIKHIL S. MARATHE, ROSELLE, IL (US); CHRISTOPHER F. BALDWIN, CRYSTAL LAKE, IL (US); BRUCE BARNES, I, PINGREE GROVE, IL (US); PATRICK JOHN KENNY, BARRINGTON, IL (US); SHADI KHOSHABA, SKOKIE, IL (US); CHARLES STAHULAK, CHICAGO, IL (US)

(73) Assignee: AT&T INTELLECTUAL PROPERTY I, L.P., Atlanta, GA (US)

(21) Appl. No.: 13/425,242

(22) Filed: Mar. 20, 2012

(51) Int. Cl. G06Q 20/22

(52) U.S. Cl. 705/39; 705/35

(57) ABSTRACT

Methods, systems, and products describe payment for charging a battery. A battery identification number is received that uniquely identifies the battery. The battery is charged with electrical power, and the electrical power consumed is metered. The battery identification number is associated to the electrical power consumed during charging the battery. A query is made for payment for the electrical power.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to electricity and to batteries and, more particularly, to charging stations for electric vehicles.

Electric vehicles (or “EVs”) have been proposed since the earliest days of the automotive industry. With today's stringent pollution laws and mileage requirements, electric vehicles are again gaining attention. All-electric vehicles and hybrid-electric vehicles are coming to market, and public charging stations are being proposed and installed throughout the country. These charging stations allow a vehicle's battery to be charged while the driver shops or works. As more people adopt battery-powered vehicles, more charging stations will be needed to meet charging demands.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIGS. 1-3 are simplified schematics illustrating an environment in which exemplary embodiments may be implemented;

FIG. 4 is a more detailed block diagram illustrating the operating environment, according to exemplary embodiments;

FIGS. 5-6 are detailed schematics illustrating a physical connection with the charging station, according to exemplary embodiments;

FIGS. 7-8 are detailed schematics illustrating a wireless connection with the charging station, according to exemplary embodiments;

FIG. 9 is a more detailed block diagram illustrating the vehicle, according to exemplary embodiments;

FIGS. 10-11 are detailed schematics illustrating a relational database, according to exemplary embodiments;

FIG. 12 is another detailed schematic illustrating the relational database, according to exemplary embodiments;

FIGS. 13-14 are more detailed schematics illustrating the relational database, according to exemplary embodiments;

FIG. 15 is a detailed schematic illustrating authentication, according to exemplary embodiments;

FIG. 16 is schematic further illustrating charging of batteries, according to exemplary embodiments;

FIGS. 17-19 are schematics illustrating diagnostic codes, according to exemplary embodiments;

FIG. 20 is a schematic illustrating the battery, according to exemplary embodiments;

FIGS. 21-22 are schematics illustrating a swapping procedure, according to exemplary embodiments;

FIG. 23 is a schematic illustrating charging parameters, according to exemplary embodiments; and

FIG. 24 is a flowchart illustrating a method of charging the battery, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

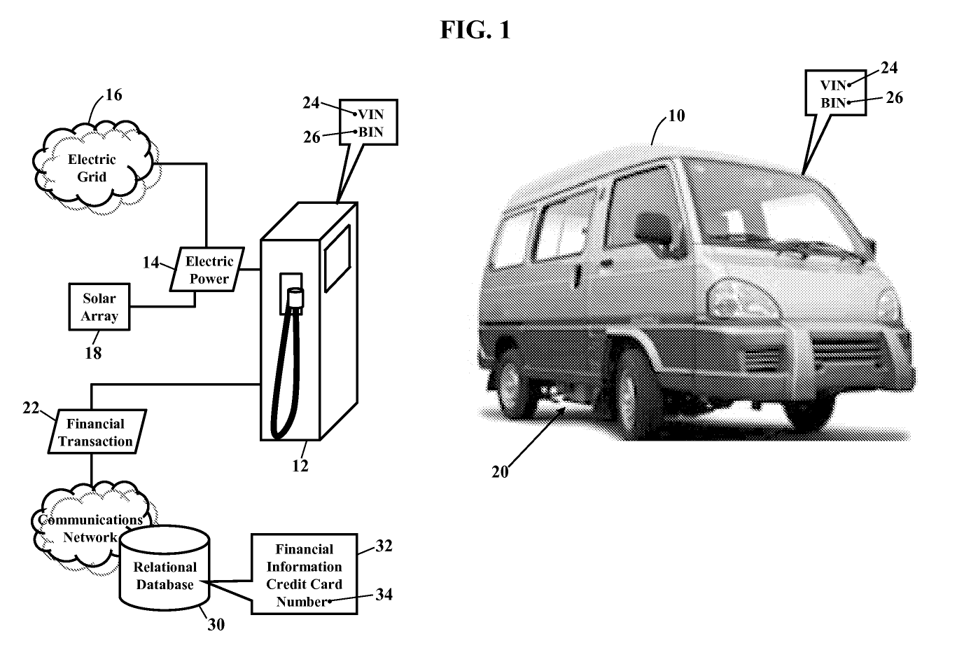

FIGS. 1-3 are simplified schematics illustrating an environment in which exemplary embodiments may be implemented. FIG. 1 illustrates a vehicle 10 and a charging station 12. The charging station 12 receives electrical power 14 (e.g., current and voltage) from the electric grid 16 and/or a solar array 18. The charging station 12 wiredly and/or wirelessly transmits some or all of the electrical power 14 to the vehicle 10. The electrical power 14 is stored in one or more batteries 20 installed within the vehicle 10. Because the vehicle 10, the charging station 12, and the batteries 20 are known, this disclosure will not dwell on the known aspects.

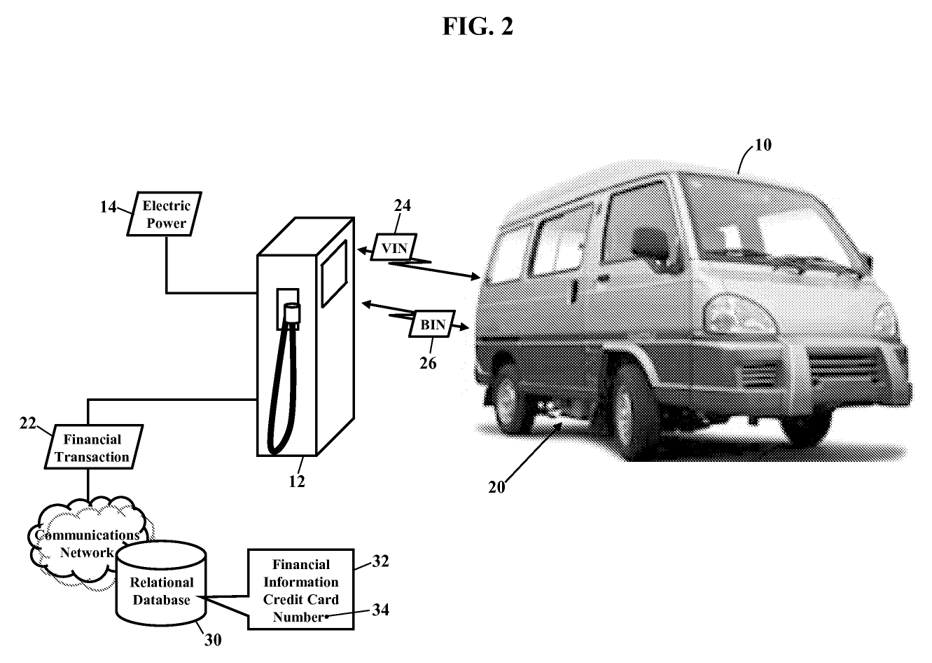

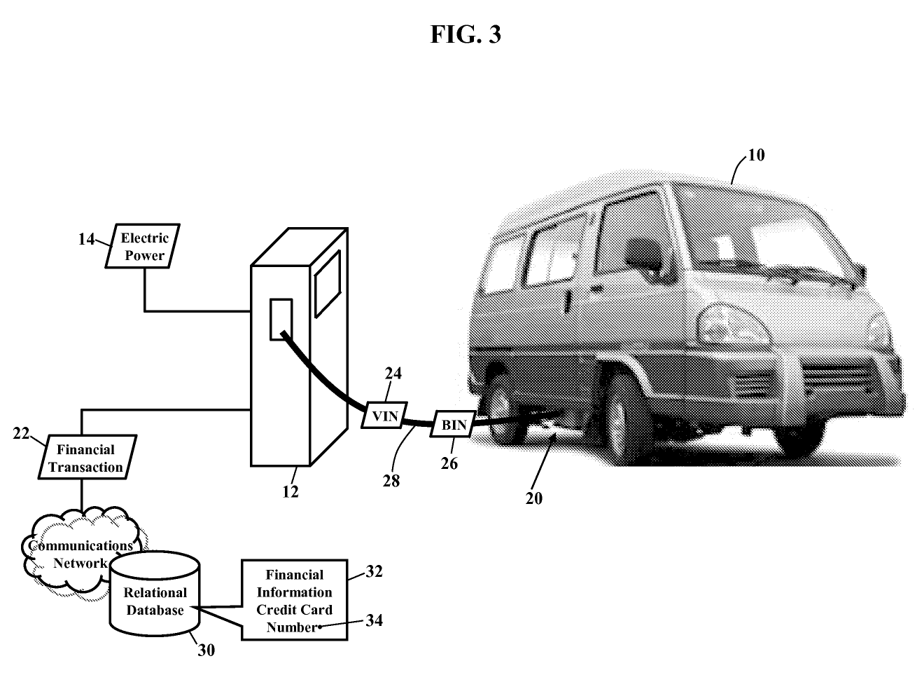

Payment, though, may be required. As the batteries 20 are charged by the charging station 12, the charging station 12 may meter the electrical power 14 consumed by the vehicle 10. That is, the charging station 12 may measure or log the electrical current and/or voltage consumed to charge the batteries 20. The charging station 12 may thus perform or process a financial transaction 22 for charging the batteries 20 installed within the vehicle 10. As FIG. 1 illustrates, the charging station 12 may receive a vehicle identification number (or “VIN”) 24 associated with the vehicle 10. The charging station 12 may also receive a battery identification number (or “BIN”) 26 associated with the one or more batteries 20. The vehicle identification number 24 uniquely identifies the vehicle 10 (such as a make, model, and/or serial number). The battery identification number 26 uniquely identifies the one or more batteries 20. FIG. 2 illustrates the vehicle identification number (“VIN”) 24 and the battery identification number (“BIN”) 26 being wirelessly transmitted from the vehicle 10 to the charging station 12. FIG. 3 illustrates the vehicle identification number (“VIN”) 24 and the battery identification number (“BIN”) 26 being wiredly transmitted along a charging cord 28 to the charging station 12. Regardless of the charging method (wireless or wired), the charging station 12 obtains the vehicle identification number 24 and/or the battery identification number 26.

The financial transaction 22 may then be conducted. Once the charging station 12 obtains the vehicle identification number 24 and/or the battery identification number 26, the charging station 12 may electronically conduct the financial transaction 22 as payment for charging the batteries 20. As FIGS. 1-3 also illustrate, the charging station 12 may query a relational database 30. The charging station 12 sends the vehicle identification number 24 and/or the battery identification number 26 to the relational database 30. The relational database 30 retrieves and returns financial information 32 associated with the vehicle identification number 24 and/or the battery identification number 26. The relational database 30, for example, may retrieve any billing information, such as a credit card number 34. The financial information 32, though, may be any account number that is processed as payment. The charging station 12 may then may conduct the electronic financial transaction 22 and electronically charge the credit card number 34 as payment for charging the batteries 20 installed in the vehicle 10.

Exemplary embodiment thus greatly simplify charging procedures. When the vehicle 10 arrives at the charging station 12, the vehicle's on-board intelligence (e.g., computer or controller) may automatically interface with the charging station 12. The vehicle 10 and the charging station 12 arrange a transfer of the vehicle identification number 24 and/or the battery identification number 26. The vehicle identification number 24 uniquely identifies the vehicle 10, while the battery identification number 26 uniquely identifies the one or more batteries 20 installed within the vehicle 10. Because the vehicle identification number 24 and/or the battery identification number 26 may be used to retrieve the financial information 32, exemplary embodiments permit a simple and automatic payment mechanism for charging the batteries 20. The vehicle 10 need only interface and perhaps authenticate to the charging station 12. The driver may thus quickly exit the vehicle 10 and proceed with other tasks without arranging payment.

As the above paragraphs explained, the battery identification number 26 uniquely identifies the batteries 20 installed within the vehicle 10. The battery identification number 26 may identify a manufacturer of the one or more batteries 20. The battery identification number 26 may additionally or alternatively identify a model of the batteries 20. The battery identification number 26 may additionally or alternatively identify a serial number associated with the batteries 20. The battery identification number 26 may even identify charging parameters, such as a preferred or recommended voltage, current, and/or time at which the batteries 20 are charged.

The battery identification number 26 may be especially useful for maintenance activities. As the one or more batteries 20 age, a time may come when the batteries 20 need replacement. As those of ordinary skill in the art understand, the service life of the batteries 20 may depend on many factors, including charging cycles, temperature, and electrical load. Indeed, the batteries may need replacement as soon as 50,000 miles, long before the serviceable life of the vehicle 10. In such cases the batteries 20 may need replacement, wherein new batteries are installed. The battery identification number 26 may thus be useful in tracking battery “swapping” procedures, as later paragraphs will explain.

As FIGS. 1-3 illustrate, exemplary embodiments may be applied to both wired and wireless charging. The driver of the vehicle 10 simply maneuvers to the charging station 12. If wired charging is desired, the driver plugs the charging cord 28 into a socket, as is known. If wireless charging is available, the vehicle 10 is maneuvered to a correct position to establish wireless communication. Regardless, the driver may then leave the vehicle 10 without any need to authorize payment or to pre-pay. Exemplary embodiments transfer the vehicle identification number 24 and/or the battery identification number 26 to the charging station 12 (perhaps over an encrypted medium, as later paragraphs will explain). Exemplary embodiments retrieve the financial information 32 associated with the vehicle identification number 24 and/or the battery identification number 26. The electrical power 14 consumed during charging is metered and billed to the credit card number 34 (or any other desired payment method).

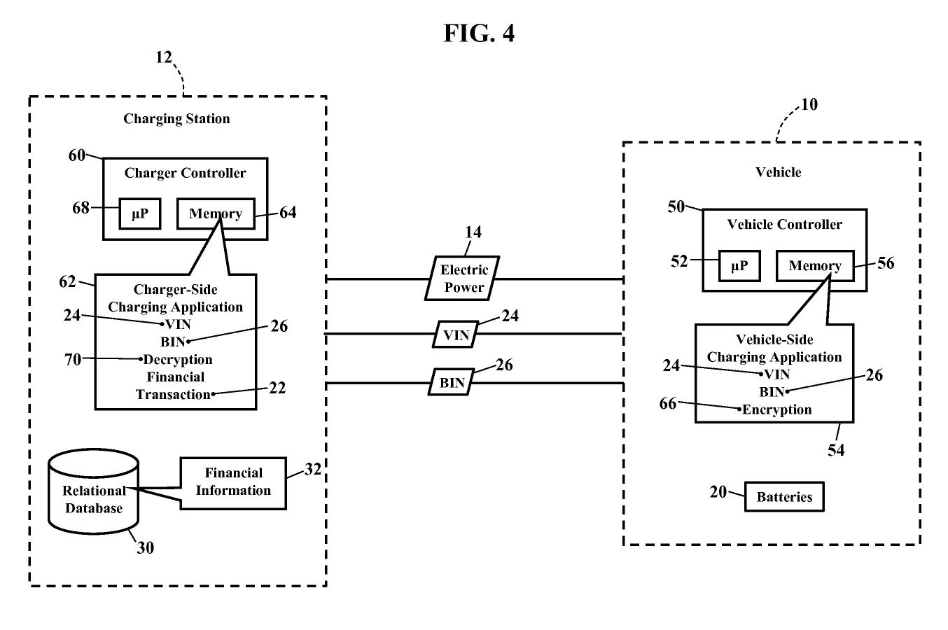

FIG. 4 is a more detailed block diagram illustrating the operating environment, according to exemplary embodiments. Here the vehicle 10 has at least one vehicle controller 50 that interfaces with the charging station 12. The vehicle controller 50 has a processor 52 (e.g., “μP”), application specific integrated circuit (ASIC), or other component that executes a vehicle-side charging application 54 stored in a memory 56. The charging station 12 has a charger controller 60 that executes a charger-side charging application 62 stored in a memory 64. The vehicle-side charging application 54 and the charger-side charging application 62 cooperate to charge the batteries 20 installed in the vehicle 10. The vehicle-side charging application 54 causes the processor 52 to retrieve the vehicle identification number 24 and/or the battery identification number 26 from the memory 56. The vehicle-side charging application 54 may even cause the processor 52 to apply any encryption 66 to the vehicle identification number 24 and/or the battery identification number 26. The vehicle-side charging application 54 also instructs the processor 52 to send the vehicle identification number 24 and/or the battery identification number 26 to the charging station 12. When the charging station 12 receives the vehicle identification number 24 and/or the battery identification number 26, the charger-side charging application 62 causes a processor 68 in the charging station 12 to perform any corresponding decryption 70, if needed. The charger-side charging application 62 then instructs the processor 68 to query the relational database 30 for the financial information 32. The charger-side charging application 62 also instructs the processor 68 to conduct the electronic financial transaction 22 as payment for charging the batteries 20 installed in the vehicle 10.

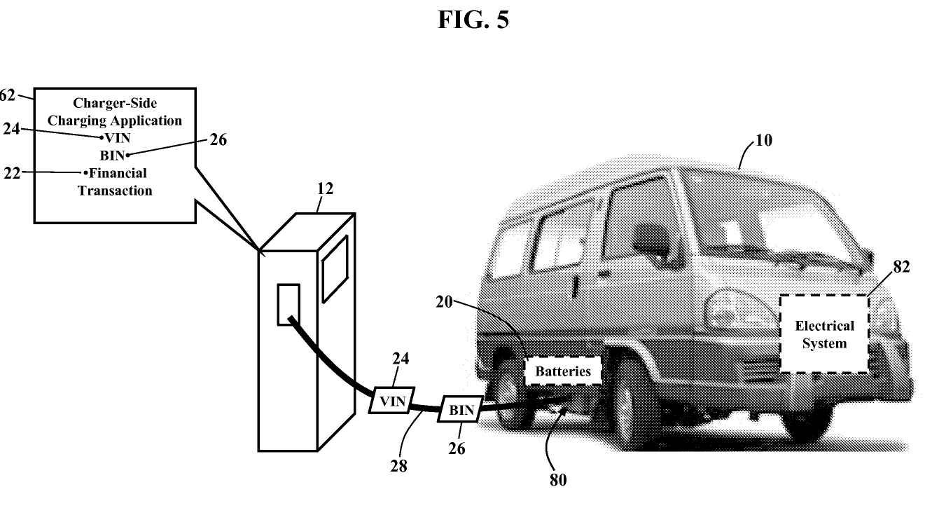

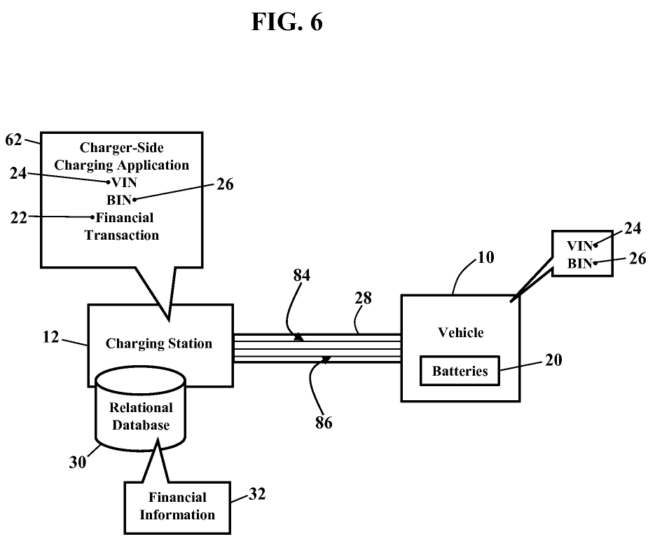

FIGS. 5-6 are detailed schematics illustrating a physical connection with the charging station 12, according to exemplary embodiments. Here the charging cord 28 physically inserts into a charging outlet 80 installed in or on the vehicle 10. The charging cord 28 and the charging outlet 80 may have any design; indeed, exemplary embodiments may utilize any size, style, and/or physical configuration of the charging cord 28 and the charging outlet 80. The vehicle 12 has an electrical system 82 that receives the electrical power 14 and stores at least some of the electrical power 14 in the batteries 20. The vehicle-side charging application 54 is a software program or instruction set that helps manage charging of the batteries 20.

FIG. 6 is a block diagram further illustrating the charging cord 28. Because the charging cord 28 conducts electricity (e.g., the electrical power 14 in FIGS. 1-5), the charging cord 28 may also convey the vehicle identification number 24 and/or the battery identification number 26. The charging cord 28 may comprise one or more conductors 84 that bi-directionally transmit signals representing the electrical power, the vehicle identification number 24, and/or the battery identification number 26. The charging cord 28 may even include a fiber optic line or cable 86 that transmits the vehicle identification number 24 and/or the battery identification number 26. Regardless, the charging station 12 obtains the vehicle identification number 24 and/or the battery identification number 26. The charging station 12 queries the relational database 30 for the financial information 32. The charging station 12 may then may conduct the electronic financial transaction 22 as payment for charging the batteries 20 installed in the vehicle 10.

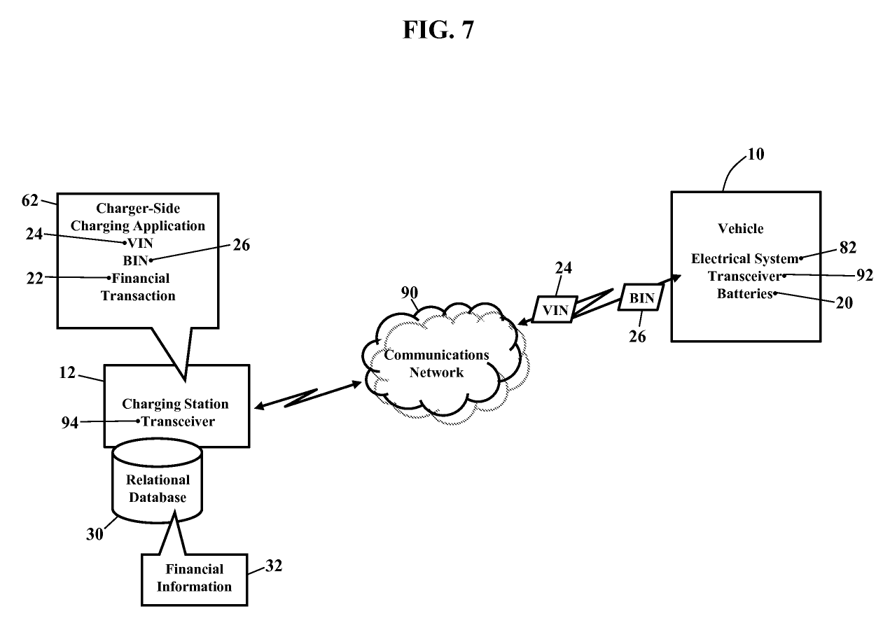

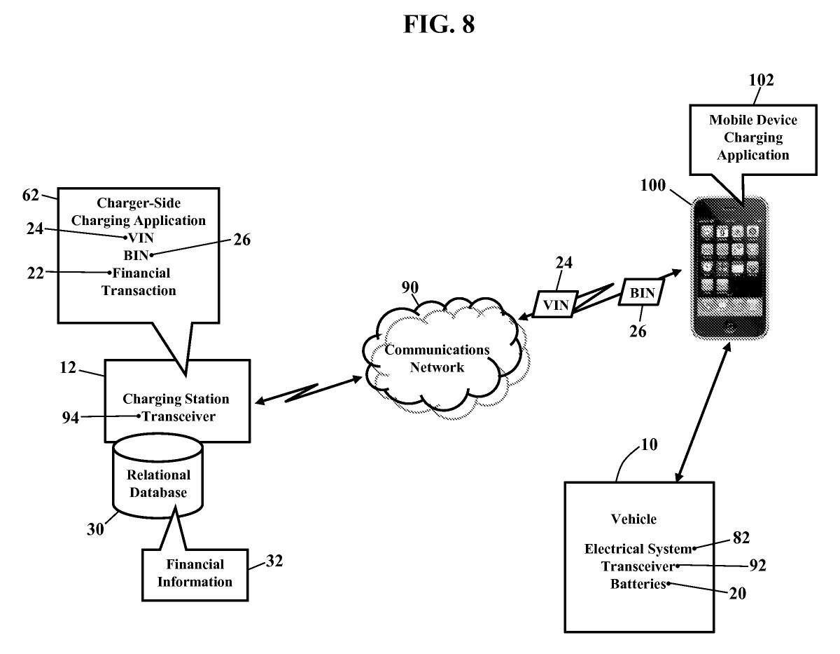

FIGS. 7-8 are detailed schematics illustrating a wireless connection with the charging station 12, according to exemplary embodiments. Here the vehicle's electrical system 82 may bi-directionally communicate with the charging station 12 using a communications network 90. As FIG. 7 illustrates, the vehicle 12 may include a wireless transceiver 92. The wireless transceiver 92 wirelessly transmits the vehicle identification number 24 and/or the battery identification number 26 to a wireless transceiver 94 operating in the charging station 12. FIG. 8 illustrates an alternative wireless environment, where a mobile communications device 100 (such as a smart phone or tablet computer) wirelessly transmits the vehicle identification number 24 and/or the battery identification number 26 to the wireless transceiver 94 operating in the charging station 12. Once the charger-side charging application 62 obtains the vehicle identification number 24 and/or the battery identification number 26, the charger-side charging application 62 causes the charging station 12 to query the relational database 30 for the financial information 32. The charging station 12 may then may conduct the electronic financial transaction 22 as payment for charging the batteries 20 installed in the vehicle 10.

Exemplary embodiments may be applied regardless of networking environment. The communications network 90 may utilize any portion of the electromagnetic spectrum and any signaling standard (such as the I.E.E.E. 802 family of standards, GSM/CDMA/TDMA or any cellular standard, and/or the ISM band). The communications network 90, for example, may utilize BLUETOOTH® or WI-FI® to convey the vehicle identification number 24 and/or the battery identification number 26. The communications network 90 may also utilize a radio-frequency domain and/or an Internet Protocol (IP) domain. The communications network 90, however, may also include a distributed computing network, such as the Internet (sometimes alternatively known as the “World Wide Web”), an intranet, a local-area network (LAN), and/or a wide-area network (WAN). The communications network 90 may also include coaxial cables, copper wires, fiber optic lines, and/or hybrid-coaxial lines. The communications network 90 may even include powerline portions, in which signals are communicated via electrical wiring. The concepts described herein may be applied to any wireless/wireline communications network, regardless of physical componentry, physical configuration, or communications standard(s).

As FIG. 8 also illustrates, software applications may be developed to transfer the vehicle identification number 24 and/or the battery identification number 26. A mobile device charging application 102, for example, may be loaded onto the mobile communications device 100. The mobile device charging application 102 may cause the mobile communications device 100 to physically or wirelessly interface with the vehicle's electrical system 82. The mobile device charging application 102 retrieves the vehicle identification number 24 and/or the battery identification number 26. The mobile communications device 100 then establishes communication with the charging station 12 and transfers the vehicle identification number 24 and/or the battery identification number 26.

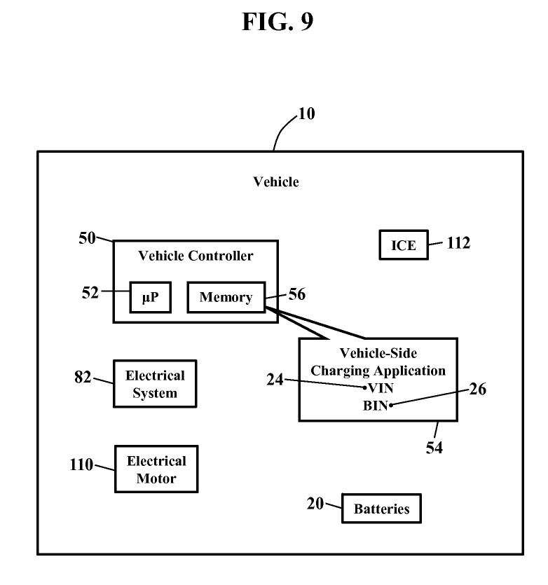

FIG. 9 is a more detailed block diagram illustrating the vehicle 10, according to exemplary embodiments. The one or more batteries 20 installed within the vehicle 10 provide electrical power to one or more electrical motors 110 and/or to the vehicle's electrical system 82. The electrical motors 110 may be used to mechanically drive the vehicle 10, perhaps using a transmission, planetary gear, or other electromechanical mechanism. The electrical system 82 distributes electrical power throughout the vehicle 10, as is known. The least one electrical controller 50 manages and/or controls the electrical motors 110 and/or the electrical system 82. The vehicle 10 may even include an internal combustion engine (“ICE”) 112. The components of the vehicle 10 are generally well-known and, thus, need not be further discussed.

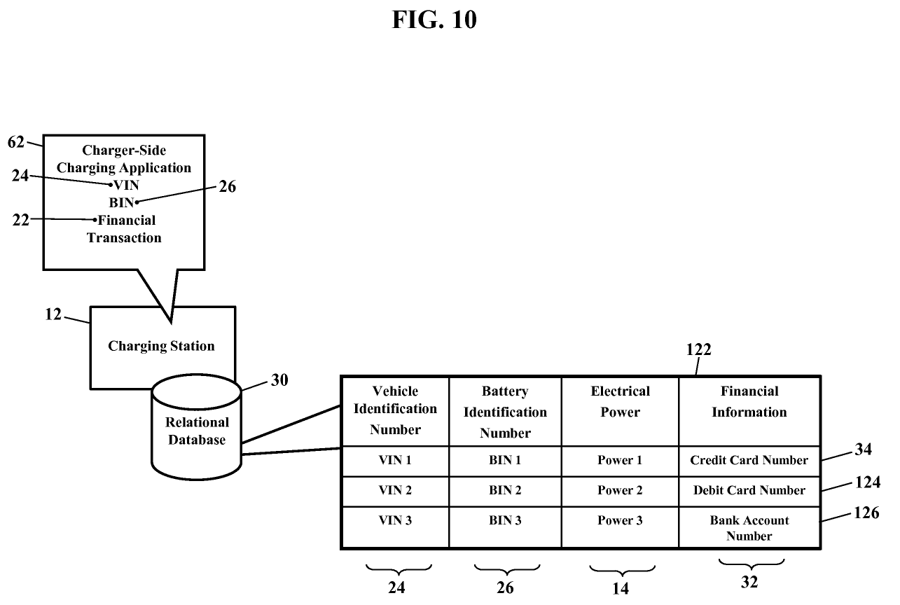

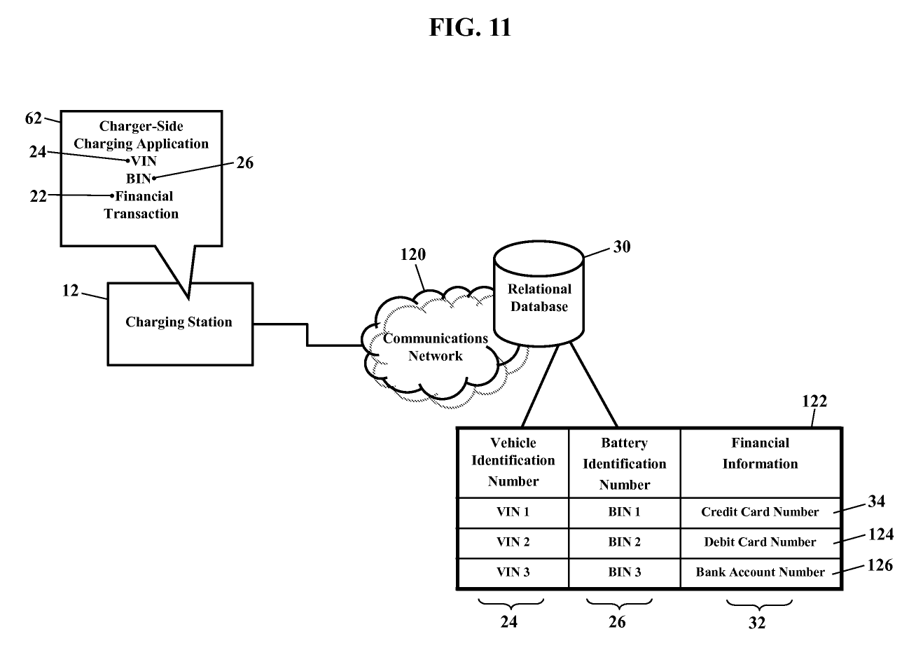

FIGS. 10-11 are detailed schematics illustrating the relational database 30, according to exemplary embodiments. FIG. 10 illustrates the relational database 30 as being locally stored in the charging station 12. FIG. 11 illustrates the relational database 30 as being remotely accessed and maintained at any location in a communications network 120. The relational database 30, in other words, may be accessed using a local area network, wide area network, or the Internet. Regardless, the relational database 30 stores the vehicle identification numbers 24, the battery identification numbers 26, and the financial information 32. FIGS. 10-11, for example, illustrate the relational database 30 as a table 122 that maps, relates, or otherwise associates the vehicle identification numbers 24 and/or the battery identification numbers 26 to different financial information 32. The financial information 32, for example, may be the credit card number 34. Once the charger-side charging application 62 obtains the vehicle identification number 24 and/or the battery identification number 26, the relational database 30 may be queried for the credit card number 34. The financial information 32, however, may additionally or alternatively include a debit card number 124 or a banking account number 126. The financial information 32, though, may be PAYPAL® information, prepaid account information, or any other information or alphanumeric code for payment. Whatever the financial information 32, the charger-side charging application 62 may even update the relational database 30 with the electrical power 14 consumed during charging. The charger-side charging application 62 may then cause the charging station 12 to generate the electronic financial transaction 22. The electronic financial transaction 22 is routed to some payment processor (such as a credit card server or other electronic banking entity). The charging station 12 thus conducts the electronic financial transaction 22 as payment for charging the batteries 20 installed in the vehicle 10.

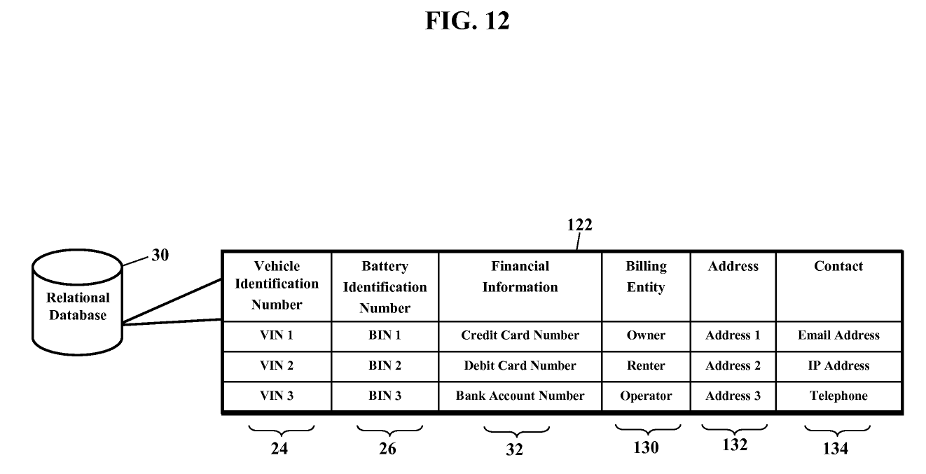

FIG. 12 is another detailed schematic illustrating the relational database 30, according to exemplary embodiments. Here the relational database 30 may also include a billing entity 130. That is, the relational database 30 may also store and map the vehicle identification numbers 24, the battery identification numbers 26, and/or the financial information 32 to a billing entity 130 that is responsible for payment. The billing entity 130, for example, may be a registered owner of the vehicle 10. The billing entity 130, however, may be a variable entity, such as a renter or operator of the vehicle 10. Regardless, the relational database 30 may have corresponding entries for an address 132 and contact information 134 of the billing entity 130. Should the electronic financial transaction 22 fail (such as a credit card denial), the charger-side charging application 62 may notify the billing entity 130. The charger-side charging application 62, for example, may send an electronic mail, send a text message, or place a call. An electronic or physical invoice may also be sent for payment. The charger-side charging application 62 may even notify the billing entity 130 each time the battery 10 is charged, thus allowing the billing entity 130 to monitor the chargings. The charger-side charging application 62 may even be configured to require authorization from the billing entity 130 before the battery 20 is charged. This approval from the billing entity 130 may even be used to track the current location of the vehicle 10.

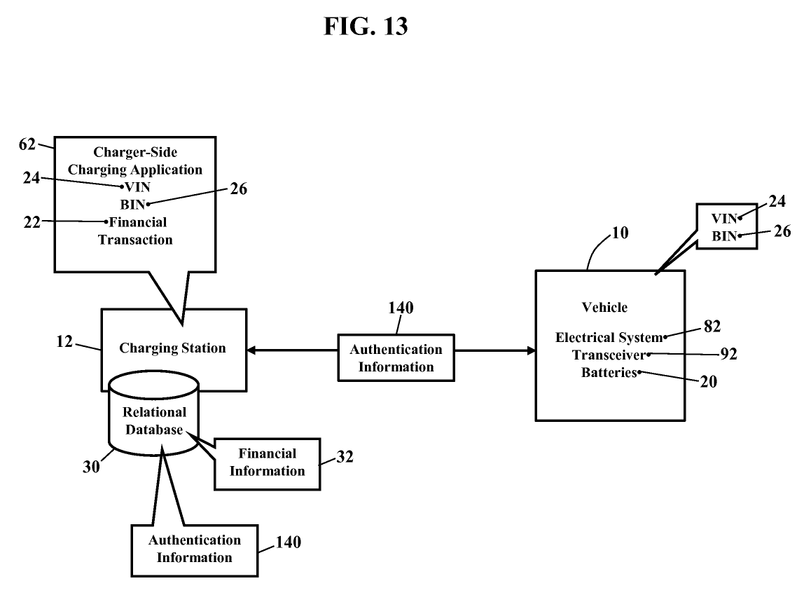

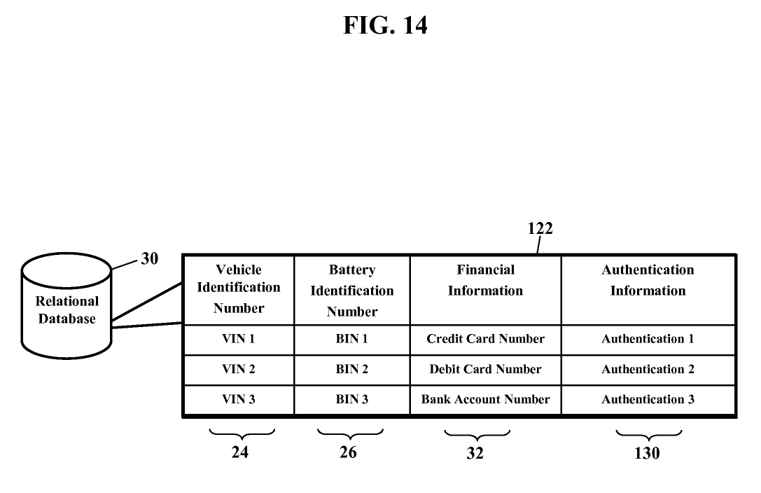

FIGS. 13-14 are more detailed schematics illustrating the relational database 30, according to exemplary embodiments. Here the relational database 30 may also include authentication information 140. As FIG. 13 illustrates, when the vehicle 10 and the charging station 12 interface, the charging station 12 may require an authentication procedure. The charger-side charging application 62, in other words, may require any authentication credentials before charging the vehicle's batteries 20. The vehicle's electrical system 82 retrieves and communicates the authentication information 140 (such as a username and password) to the charging station 12. The charger-side charging application 62 then queries the relational database 30 for the vehicle identification number 24 and/or the battery identification number 26. As FIG. 14 illustrates, the relational database 30 may also store the authentication information 140 associated with the vehicle identification number 24 and/or the battery identification number 26. If the authentication information 140 received from the vehicle 10 matches the authentication information 140 stored in the relational database 30, then the charger-side charging application 62 authorizes charging of the batteries 20.

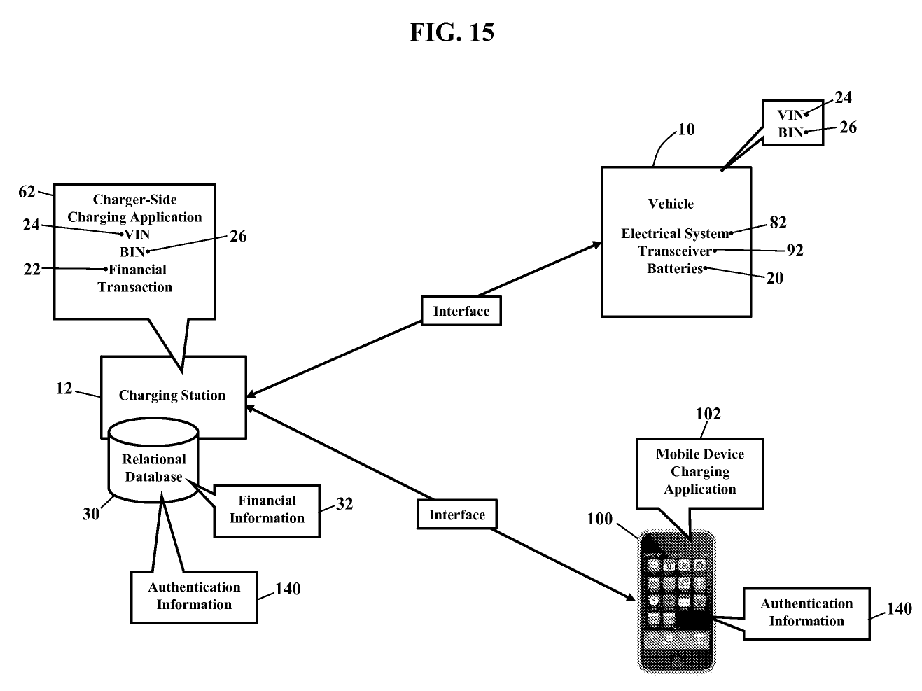

FIG. 15 is another detailed schematic illustrating authentication, according to exemplary embodiments. Here, though, the authentication information 140 is wirelessly obtained from the mobile communications device 100. When the vehicle 10 and the charging station 12 interface, the charging station 12 may obtain the authentication information 140 from the mobile communications device 100. That is, the driver's or occupant's smart phone or tablet computer may wirelessly transmit the authentication information 140 to the charging station 12. The charger-side charging application 62 may also obtain the vehicle identification number 24 and/or the battery identification number 26 (as earlier paragraphs explained). The charger-side charging application 62 then compares the authentication information 140 to those stored in the relational database 30. If the authentication information 140 received from the mobile communications device 100 matches the authentication information 140 stored in the relational database 30, then the charger-side charging application 62 may authorize charging of the batteries 20.

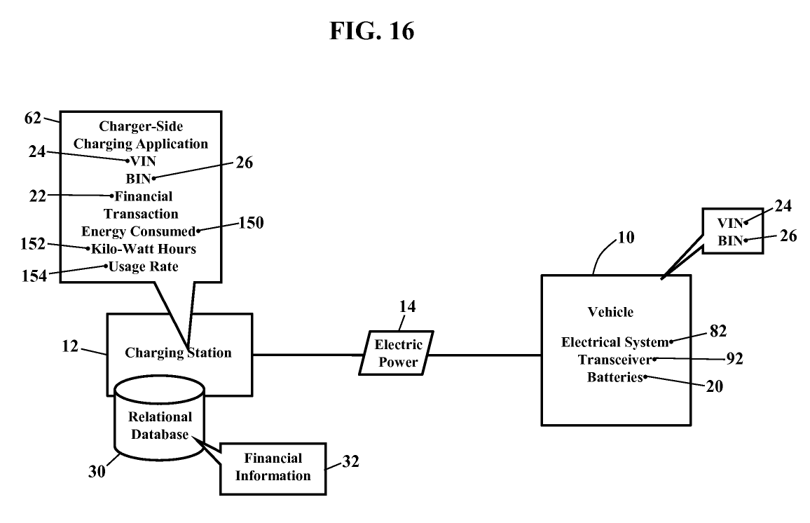

FIG. 16 is schematic further illustrating charging of the batteries 20, according to exemplary embodiments. Here the charging station 12 may measure or meter the electrical power 14 consumed during charging of the batteries 20. The charger-side charging application 62 measures the energy consumed 150 by the vehicle 10 during charging of the batteries 20. The charger-side charging application 62, for example, may monitor the electrical power 14 and convert to kilowatt-hours 152, as is commonly done by electrical utilities. The charger-side charging application 62 may also retrieve, or query for, a usage rate 154 associated with the time of day. The usage rate 154 and the energy consumed 150 are then used to compute a total bill and to conduct the electronic financial transaction 22 as payment.

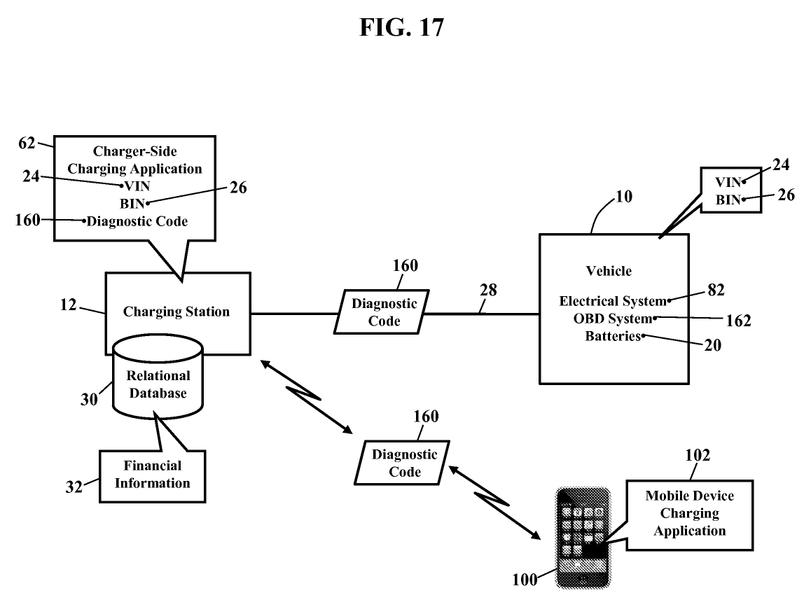

FIGS. 17-19 are schematics illustrating diagnostic codes, according to exemplary embodiments. As the charging station 12 charges the batteries 20 in the vehicle 10, the charging station 12 may also receive a diagnostic code 160 from the vehicle's electrical system 82. The diagnostic code 160 is generated by an On-Board Diagnostic (or “OBD”) system 162. As those of ordinary skill in the art understand, the On-Board Diagnostic system 162 monitors various electrical and mechanical components in the vehicle 10 and reports status and errors. When the vehicle 10 and the charging station 12 interface, the On-Board Diagnostic system 162 may cause the diagnostic code 160 to be sent to the charging station 12. The diagnostic code 160, for example, may be sent over the physical charging cord 28, or the diagnostic code 160 may be wirelessly transmitted from the vehicle 10 (as earlier paragraphs explained). The diagnostic code 160 may even be wirelessly transmitted from the mobile communications device 100. Regardless, when the charging station 12 receives the diagnostic code 160, the diagnostic code 160 may then be conveniently used to benefit the driver.

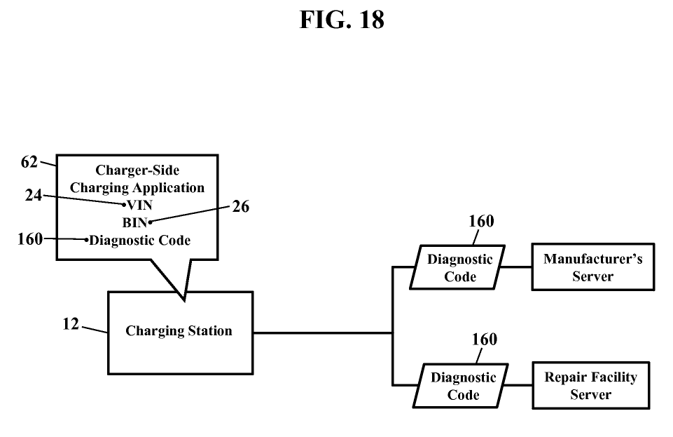

As FIG. 18 illustrates, the diagnostic code 160 may improve service. The diagnostic code 160, for example, may be routed over a communications network to a manufacturer's server 162. When the manufacturer's server 162 receives the diagnostic code 160, the diagnostic code 160 may be stored and analyzed to improve operations. For example, the diagnostic code 160 may be used to catalog warranty items and to determine design changes. The diagnostic code 160, however, may also be routed over the communications network to a repair facility's server 164. A dealership may use the diagnostic code 160 as an opportunity to generate a service inquiry. The dealership may contact the vehicle 10, or the mobile communications device 100, to initiate a revenue opportunity. The charging station 12, in other words, may help resolve diagnostic errors reported by the vehicle 10.

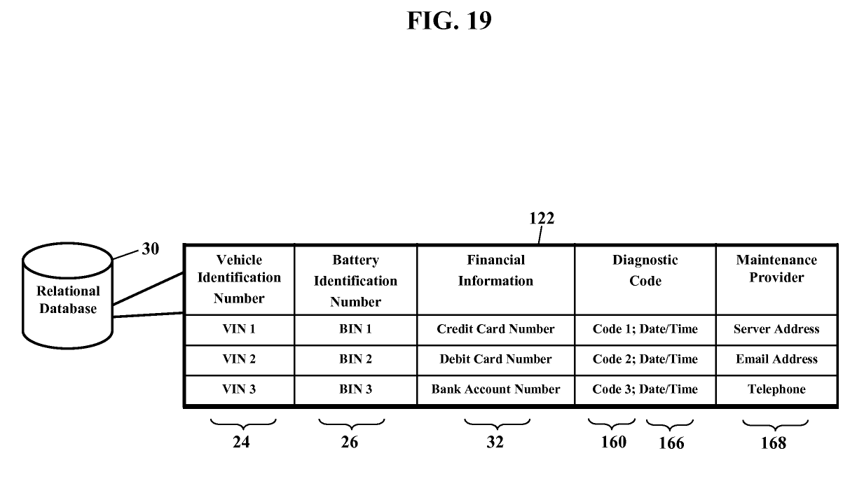

As FIG. 19 illustrates, the diagnostic code 160 may be stored in the relational database 30. When the charging station 12 receives the diagnostic code 160, the charger-side charging application 62 may add the diagnostic code 160 to the relational database 30. The diagnostic code 160 may thus be associated with the vehicle identification number 24 and/or the battery identification number 26. The charger-side charging application 62 may even add a date and time stamp 166 that logs a date/time of occurrence or receipt. The relational database 30 may include an entry for a maintenance provider 168 (such as a communications address or telephone number of a dealer or preferred repair facility). When the diagnostic code 160 is received, the charger-side charging application 62 may notify the maintenance provider 168 by electronic message (e.g., email or text) or call. The charger-side charging application 62 may even schedule an appointment to have the diagnostic code 160 investigated and resolved.

The ability to report diagnostic codes is helpful. Because the diagnostic code 160 may be retrieved with each charging cycle, exemplary embodiments may frequently report any issues detected by the On-Board Diagnostic system 162. Many drivers will charge their vehicle 10 at least once per day, so exemplary embodiments may provide a nearly daily diagnostic report of the health of the vehicle 10. Indeed, because the On-Board Diagnostic system 162 may even monitor the performance or present condition of the batteries 20, the relational database 30 may store a daily log of the health of the batteries 20.

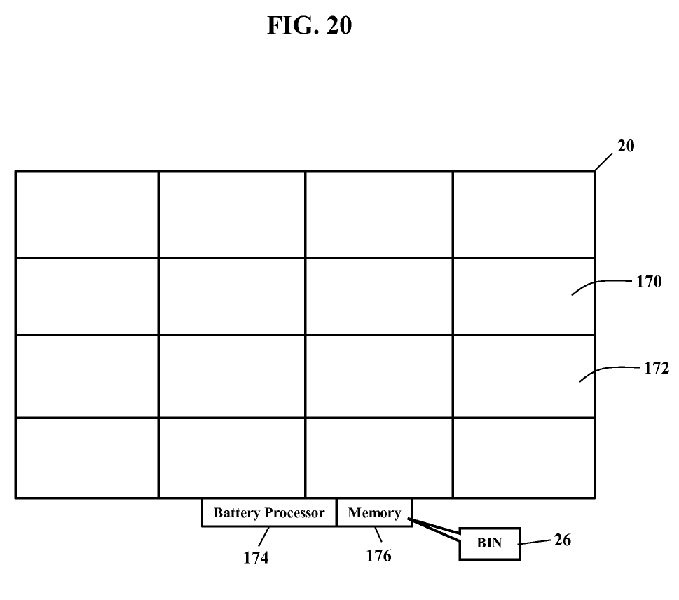

FIG. 20 is a schematic illustrating the at least one battery 20, according to exemplary embodiments. The battery 20 comprises one or more cells 170 arranged in a series or parallel electrical configuration. Each cell has a chemical composition 172, such as lead-acid, lithium ion, or nickel metal hydride. The number of the cells 170 and the chemical composition 172 are not important, as the exemplary embodiments may be applied to any battery construction. The at least one battery 20, though, may have its own dedicated processor 174 and memory 176. That is, the at least one battery 20 may be a smart design that stores and provides the battery identification number 26. The battery's processor 174 and memory 176 may interface with the vehicle's electrical system 82 to pass the battery identification number 26 to the charging station 12. When the battery 20 stores the battery identification number 26, the vehicle 10 may not store the battery identification number 26 in long-term memory. That is, for enhanced security, the vehicle 10 (such as the vehicle controller 50 illustrated in FIG. 9) may only retrieve and store the battery identification number 26 in short term or volatile memory. When the battery 20 is removed from the vehicle 10, the vehicle controller 50 may not use the stored battery identification number 26 for further authentication. The battery identification number 26, in other words, must be reinitialized or reacquired when the battery 10 is removed and/or replaced. Perhaps disconnection of the battery 20, and a concomitant loss in electrical power, may erase the battery identification number 26 from the memory 56 of the vehicle controller 50.

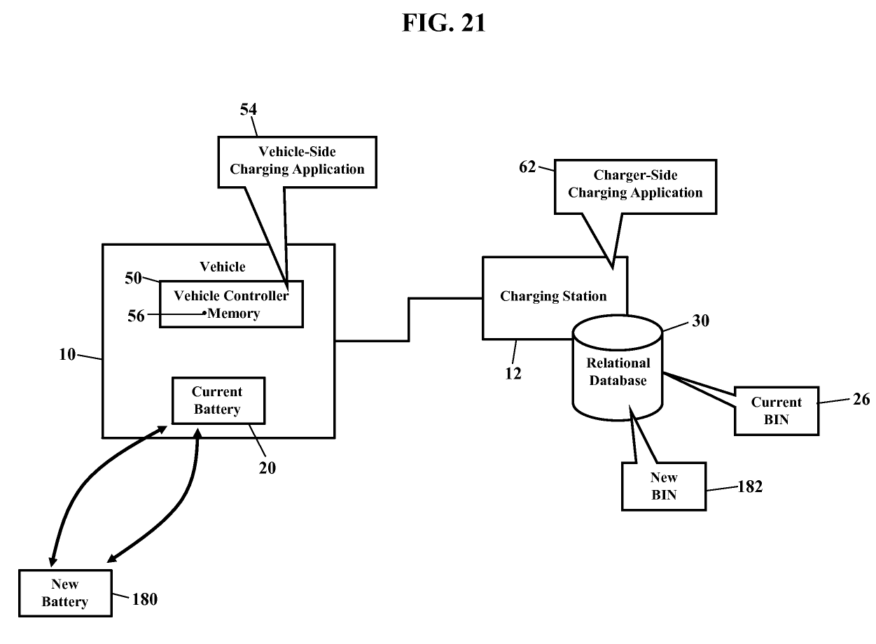

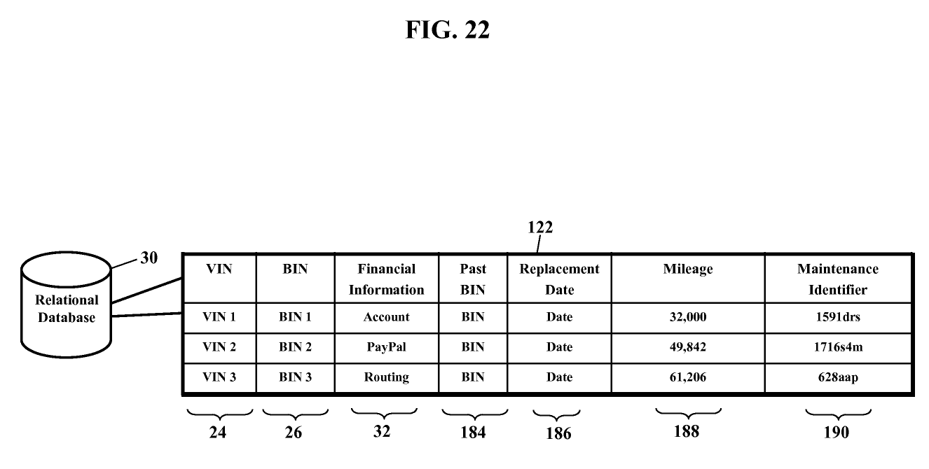

FIGS. 21-22 are schematics illustrating a swapping procedure, according to exemplary embodiments. As earlier paragraphs explained, the vehicle's battery 20 has a finite life that is commonly much less that the vehicle's life. The service life of the batteries 20 may depend on many factors, including the number of charging cycles, operating temperatures, and electrical loads. The batteries 20 may thus need replacement long before the vehicle 10 wears out. In such cases the relational database 30 may track the replacement history. FIG. 21 thus illustrates how any “swapping” of the batteries 20 may be logged in the relational database 30. When the currently-installed batteries 20 wear out and no longer maintain an adequate charge, the battery 20 may be removed from the vehicle 10 and a new battery pack 180 installed. That is, the new battery pack 180 is swapped for the current battery pack 20. Because the currently-installed batteries 20 have been replaced, the corresponding battery identification number 26 must be updated. A maintenance technician, for example, may upload a new battery identification number 182 into the memory 56 of the vehicle controller 50. Alternatively, the new battery pack 180 may self-identify and report the new battery identification number 182 to the vehicle controller 50. Regardless, when the new battery pack 180 needs charging, the vehicle-side charging application 54 may retrieve and send the new battery identification number 182 to the charging station 12. The charger-side charging application 62 will detect the new battery identification number 26 and update the relational database 30.

As FIG. 22 illustrates, the relational database 30 may track or store a history of the batteries installed in the vehicle 10. The relational database 30 may thus log each replacement of the batteries in the vehicle 10. The relational database 30 may thus store the battery identification number 26 that is currently installed in the vehicle 10, along with one or more past battery identification numbers 184 previously installed in the vehicle 10. The relational database 30 may also store a date/time 186 of replacement, a mileage 188 when replaced, and an identifier 190 of a repair facility performing the replacement.

The relational database 30 may require access authentication. Before any data in the relational database 30 is changed or updated, the relational database 30 may require an authentication procedure. For example, perhaps only the registered owner of the vehicle 10 may update the battery identification number 26 that is currently installed in the vehicle 10, along with the date/time 186 of replacement and the mileage 188. Likewise, perhaps only the registered owner of the vehicle 10 may update the financial information 32 or any other billing information stored in the relational database 30. The registered owner of the vehicle 10 may choose the authentication procedure, such as a username and password. A manufacturer of the vehicle 10, though, may require that the relational database 30 only be accessible to dealers or authorized service centers. If the vehicle 10 operates as a rental, an employee of AVIS® or HERTZ® may update the relational database 30 with each rental. A customer representative may ask if the renter desires to be financially responsible for charging the batteries 20. If the renter agrees, the customer representative may update the relational database 30 with the renter's credit card number 34 or other billing information.

The relational database 30 may be stored or maintained by any server. The relational database 30, for example, may be maintained by a governmental or commercial entity that makes the records available for disclosure. The relational database 30 may thus store the battery identification numbers 26 currently and historically associated with any vehicle identification number 24. Law enforcement, a dealer, or a potential purchaser may query the relational database 30 and obtain a complete maintenance history of the batteries 20 installed in any vehicle. Questions regarding proper installation and ownership may thus be quickly resolved.

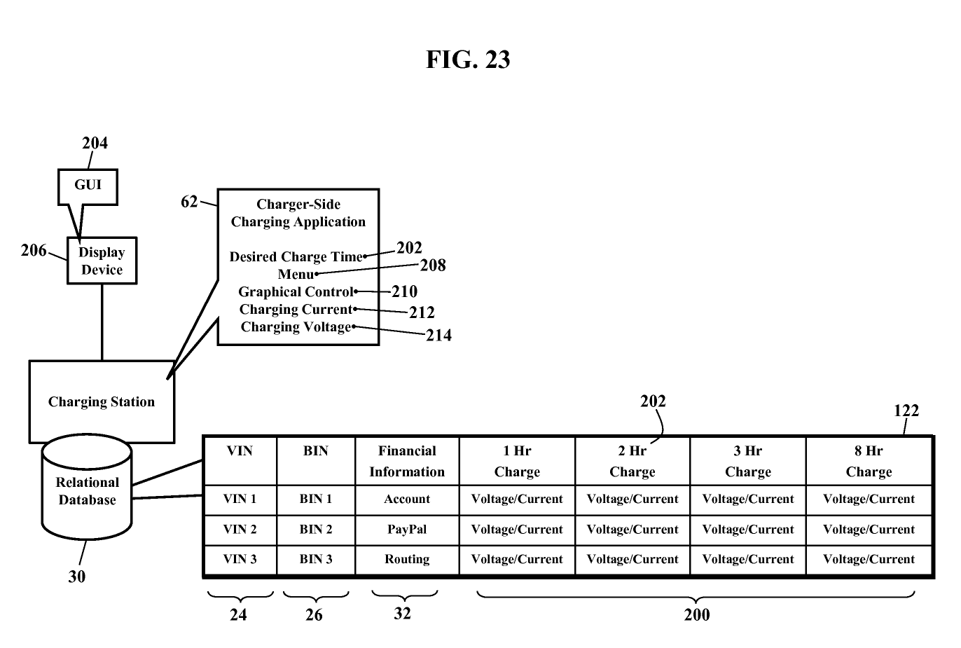

FIG. 23 is a schematic illustrating charging parameters, according to exemplary embodiments. Here the relational database 30 may also store the charging parameters 200 that are used to recharge the batteries 20 installed in the vehicle 10. Once the batteries 20 are uniquely identified from the battery identification number 26, the charging station 12 may query the relational database 30 for the appropriate charging parameters 200. The charging parameters 200, for example, may include data for charging the batteries 20, given a desired charging time 202. For example, suppose the driver of the vehicle only has three (3) hours in which to conduct a charging cycle. When the vehicle 10 and the charging station 12 interface, the driver may optionally select the desired charge time 202 using a graphical user interface 204 presented on a display device 206 of the charging station 12. The charger-side charging application 62 may thus graphically present a menu 208 of desired charging times, and the graphical user interface 204 has graphical controls 210 for selecting the desired charge time 202. Once the driver's desired charge time 202 is known, the charger-side charging application 62 queries for the charging parameters 200 associated with the battery identification number 26. The charger-side charging application 62 may thus retrieve a charging current 212 and/or charging voltage 214 that will fully charge the batteries within the desired charge time 202. The charging parameters 200 may thus be represented as a data table that specifies the charging current 212 and/or charging voltage 214 for different desired charge times 202. The charger-side charging application 62 thus meters the electrical power 14 delivered to the vehicle 10 to satisfy the charging current 212 and/or the charging voltage 214 within the desired charging time 202.

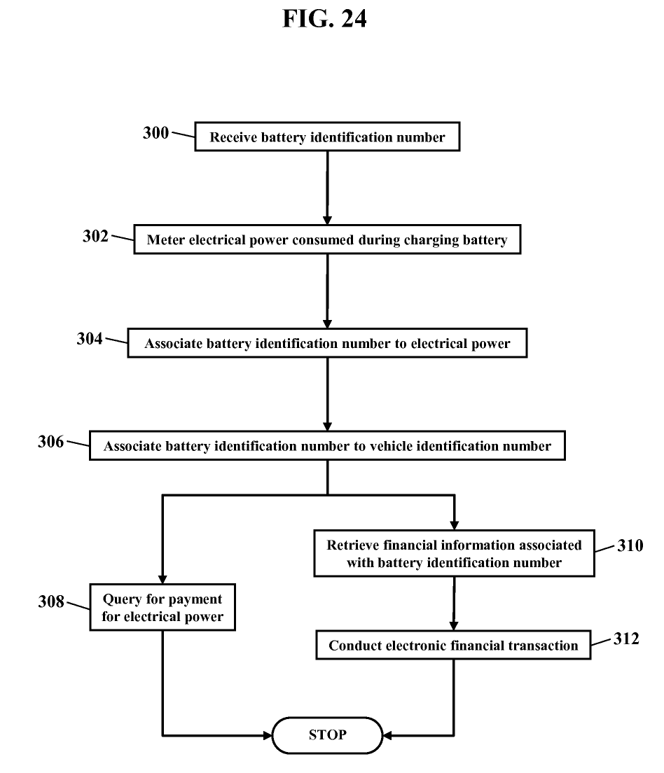

FIG. 24 is a flowchart illustrating a method of charging the battery 20, according to exemplary embodiments. The battery identification number 26 is received (Block 300) and the electrical power 14 consumed during charging is metered (Block 302). The battery identification number 26 is associated to the electrical power 14 consumed during charging the battery 20 (Block 304). The battery identification number 26 may be associated to a vehicle identification number (Block 306). A query is then made (perhaps to a third party processor) for payment of the electrical power 14 (Block 308). If desired, financial information associated with the battery identification number may be retrieved (Block 310) and an electronic financial transaction is conducted as the payment for charging the battery (Block 312).

Exemplary embodiments may be physically embodied on or in a computer-readable storage medium. This computer-readable medium may include CD-ROM, DVD, tape, cassette, floppy disk, memory card, USB, and large-capacity disks. This computer-readable medium, or media, could be distributed to end-subscribers, licensees, and assignees. A computer program product comprises processor-executable instructions for charging batteries, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising:
receiving a battery identification number that uniquely identifies a battery;
metering electrical power consumed during charging the battery;
associating the battery identification number to the electrical power consumed during charging the battery; and
querying for payment of the electrical power.

2. The method according to claim 1, further comprising querying a database that associates battery identification numbers to financial information.

3. The method according to claim 1, further comprising retrieving the financial information associated with the battery identification number.

4. The method according to claim 3, wherein retrieving the financial information comprises retrieving a credit card number associated with the battery identification number.

5. The method according to claim 1, further comprising conducting an electronic financial transaction as the payment for charging the battery.

6. The method according to claim 1, further comprising associating a vehicle identification number to the battery identification number.

7. The method according to claim 1, further comprising retrieving a date of replacement associated with the battery identification number.

8. The method according to claim 1, further comprising receiving an authentication to charge the battery.

9. A system, comprising:
a processor;
memory; and
code stored in the memory that causes the processor at least to:
receive a battery identification number that uniquely identifies a battery installed in a vehicle;
meter electrical power consumed during charging the battery;
associate the battery identification number to the electrical power consumed during charging the battery;
query for financial information associated with the battery identification number; and
conduct an electronic financial transaction as payment for charging the battery installed in the vehicle.

10. The system according to claim 9, further comprising code that causes the processor to receive a vehicle identification number that uniquely identifies the vehicle.

11. The system according to claim 9, further comprising code that causes the processor to receive a diagnostic code associated with the vehicle.

12. The system according to claim 9, further comprising code that causes the processor to retrieve a credit card number associated with the battery identification number.

13. The system according to claim 9, further comprising code that causes the processor to receive an authentication to charge the battery installed in the vehicle.

14. The system according to claim 9, further comprising code that causes the processor to decrypt the battery identification number.

15. A computer readable medium storing processor executable instructions for performing a method, the method comprising:
receiving a battery identification number that uniquely identifies a battery installed in a vehicle;
querying a database that associates battery identification numbers to financial information;
retrieving the financial information associated with the battery identification number; and
conducting an electronic financial transaction as payment for charging the battery installed in the vehicle.

16. The computer readable medium according to claim 15, further comprising instructions for receiving a vehicle identification number that uniquely identifies the vehicle.

17. The computer readable medium according to claim 16, further comprising instructions for receiving a diagnostic code associated with the vehicle.

18. The computer readable medium according to claim 15, further comprising instructions for retrieving a credit card number associated with the battery identification number.

19. The computer readable medium according to claim 15, further comprising instructions for metering electrical power consumed during charging the battery.

20. The computer readable medium according to claim 15, further comprising instructions for receiving an authentication to charge the battery installed in the vehicle.
